(19) United States
(12) Patent Application Publication
(10) Pub. No.: US 2015/0136295 A1
(43) Pub. Date: May 21, 2015

(54) TWO-LAYER MULTI-STRAND METAL CABLE

(71) Applicants: COMPAGNE GENERALE DES ETABLLISSMENTS MICHELIN, France (FR); Michelin Recherche et Technique S.A., Granges-Paccot (CH)

(72) Inventors: Henri Barguet, Clermont-Ferrand (FR); Emmanuel Clement, Clermont-Ferrand (FR); Thibault Rapenne, Clermont-Ferrand (FR); Thibaud Pottier, Clermont-Ferrand (FR)

(73) Assignees: COMPAGNE GENERALE DES ETABLISSEMENTSMICHELIN, CLERMONT-FERRAND (FR); Michelin Recherche et Technique S.A., GRANGES-PACCOT (FR)

(21) Appl. No.: 14/403,029

(22) PCT Filed: May 23, 2013
(86) PCT No.: PCT/EP2013/060565

§ 371 Date: Nov. 21, 2014

(30) Foreign Application Priority Data
May 25, 2012 (FR) 1254839

(51) Int. Cl. B60C 9/00; D02G 3/48; B60C 9/18; D07B 1/06

(52) U.S. Cl. CPC B60C 9/0007; D07B 1/0633; D02G 3/48; B60C 9/18
USPC 152/527; 57/214

(57) ABSTRACT

A two-layer multistrand metal cord includes an inner cord layer and an outer cord layer. The inner cord layer is formed of K>1 inner strands, which are wound in a helix. The outer cord layer is unsaturated and formed of L>1 outer strands, which are wound in a helix around the inner cord layer. Each strand of the inner cord layer and the outer cord layer includes an inner strand layer and an outer strand layer. The inner strand layer is formed of two inner wires. The outer strand layer is formed of N outer wires, which are wound in a helix around the inner strand layer.

The invention relates to multistrand cords that can be used in particular for reinforcing tyres, particularly tyres for heavy industrial vehicles.

A tyre having a radial carcass reinforcement comprises a tread, two inextensible beads, two sidewalls connecting the beads to the tread and a belt, or crown reinforcement, arranged circumferentially between the carcass reinforcement and the tread. This belt comprises a plurality of rubber plies, optionally reinforced with reinforcing elements or reinforcers such as cords or monofilaments, of the metal or textile type.

The tyre belt is generally constituted of at least two superimposed belt plies, sometimes referred to as “working” plies or “cross” plies, the, generally metal, reinforcing cords of which are positioned virtually parallel to one another inside a ply, but crossed from one ply to the other, that is to say inclined, symmetrically or asymmetrically, with respect to the median circumferential plane, by an angle which is generally between 10° and 45°, according to the type of tyre under consideration. The cross plies may be supplemented by various other auxiliary plies or layers of rubber, with widths that may vary as the case may be, and which may or may not contain reinforcers. Mention will be made by way of example of simple rubber cushions, of “protective” plies which have the role of protecting the remainder of the belt from external attacks or perforations, or also of “hooping” plies which contain reinforcers that are oriented substantially in the circumferential direction (what are known as “zero-degree” plies), whether these be radially outer or inner with respect to the cross plies.

A tyre of a heavy industrial vehicle, in particular of construction plant type, is subjected to numerous attacks. Specifically, this type of tyre usually runs on an uneven road surface, sometimes resulting in perforations in the tread. These perforations allow the entry of corrosive agents, for example air and water, which oxidize the metal reinforcers of the crown reinforcement and considerably reduce the useful life of the tyre.

A cord for protective plies for a tyre of a heavy industrial vehicle is known from the prior art. This cord has a structure of the 4×(1+5) type and comprises four strands that each comprise an inner layer constituted of one wire and an outer layer constituted of five wires wound in a helix around the wire of the inner layer.

This prior art cord has resistance to corrosion and elasticity that are acceptable but a relatively limited force at break which, although satisfactory for some uses, is not sufficient for particular uses, in particular in the case of a cord for tyres of heavy industrial vehicles.

The aim of the invention is thus a multistrand cord that is resistant to corrosion and has a high force at break.

To this end, one subject of the invention is a two-layer multistrand metal cord, comprising:
an inner layer of the cord, which layer is constituted of K inner strands that are wound in a helix, K being strictly greater than 1; and
an outer layer of the cord, which layer is unsaturated and constituted of L outer strands that are wound in a helix around the inner layer of the cord, L being strictly greater than 1,
   each inner and outer strand comprising:
an inner layer of the strand, which layer is constituted of 2 wires; and
an outer layer of the strand, which layer is constituted of N wires that are wound in a helix around the inner layer of the strand.

By definition, an unsaturated layer of strands is such that there is sufficient room in this layer to add at least one (L+1)th strand having the same diameter as the L strands of the layer thereto, it thus being possible for a plurality of strands to be in contact with one another. Conversely, this layer is referred to as saturated if there was not enough room in this layer to add at least one (L+1)th strand having the same diameter as the L strands of the layer thereto.

The cord has high resistance to corrosion. Specifically, the unsaturation of the outer layer of the cord makes it possible to create at least one passage opening for the rubber between two outer strands such that the rubber can penetrate effectively during the vulcanization of the tyre. The 2+N structure of each strand boosts the passage of the rubber. Specifically, each strand has an envelope with an elongate contour, this promoting the lack of contact between the adjacent strands and thus the passage of the rubber.

Moreover, the cord according to the invention has noteworthy strength properties. The strength of a cord can be measured in terms of the value of its force at break and characterizes its capacity of structural strength with respect to a force.

The multistrand structure (K+L)×(2+N) of the cord gives the cord excellent mechanical strength, in particular a high force at break.

The structure of the cord according to the invention makes it possible to manufacture protective crown plies, for example working plies or cross plies, having a relatively high linear density. Thus, the strength of the tyre is greatly improved.

When the cord is used in a protective ply, the protective plies are rendered more resilient and more resistant to corrosion on account of its high penetrability, which allows the rubber to protect the cord from corrosive agents.

When the cord is used in a working ply or cross ply, by virtue of its high mechanical strength, in particular its compression fatigue strength, the cord according to the invention gives the tyre high endurance with respect in particular to the phenomenon of separation/cracking of the ends of the cross plies in the shoulder region of the tyre, known under the term “cleavage”.

The term “metal cord” is understood by definition to mean a cord formed of wires constituted predominantly (i.e. more than 50% of these wires) or entirely (100% of the wires) of a metallic material. The invention is preferably implemented with a steel cord, more preferably a cord made of pearlitic (or ferritic-pearlitic) carbon steel referred to as “carbon steel” below, or else made of stainless steel (by definition steel comprising at least 11% chromium and at least 50% iron). However, it is of course possible to use other steels or other alloys.

When a carbon steel is used, its carbon content (% by weight of steel) is preferably comprised between 0.4% and 1.2%, in particular between 0.5% and 1.1%; these contents represent a good compromise between the mechanical properties required for the tyre and the feasibility of the wires. It should be noted that a carbon content of between 0.5% and 0.6% ultimately renders such steels less expensive as they are easier to draw. Another advantageous embodiment of the invention can also consist, depending on the applications targeted, in using steels having a low carbon content, for example of between 0.2% and 0.5%, due in particular to a lower cost and to a greater ease of drawing.

The metal or the steel used, whether in particular it is a carbon steel or a stainless steel, may itself be coated with a metal layer which, for example, improves the workability of the metal cord and/or of its constituent elements, or the use properties of the cord and/or of the tyre themselves, such as properties of adhesion, corrosion resistance or resistance to ageing.

According to one preferred embodiment, the steel used is covered with a layer of brass (Zn—Cu alloy) or of zinc. It will be recalled that, during the process of manufacturing the wires, the brass or zinc coating makes the wire easier to draw, and makes the wire adhere to the rubber better. However, the wires could be covered with a thin layer of metal other than brass or zinc having, for example, the function of improving the corrosion resistance of these wires and/or their adhesion to the rubber, for example a thin layer of Co, Ni, Al, of an alloy of two or more of the compounds Cu, Zn, Al, Ni, Co, Sn.

A person skilled in the art will know how to manufacture steel wires having such properties, in particular by adjusting the composition of the steel and the final degree of work hardening of these wires, depending on its particular specific requirements, by using for example micro-alloyed carbon steels containing specific addition elements such as Cr, Ni, Co, V or various other known elements (see for example Research Disclosure 34984—“Micro-alloyed steel cord constructions for tyres”—May 1993; Research Disclosure 34054—“High tensile strength steel cord constructions for tyres”—August 1992).

Advantageously, the outer layer of each strand is unsaturated.

By definition, an unsaturated layer of wires is such that there is sufficient room in this layer to add at least one (N+1)th wire having the same diameter as the N wires of the layer thereto, it thus being possible for a plurality of wires to be in contact with one another. Conversely, this layer is referred to as saturated if there was not enough room in this layer to add at least one (N+1)th wire having the same diameter as the N wires of the layer thereto.

The protection of the cord from corrosion is improved for similar reasons to those given in relation to the unsaturation of the outer layer of the cord. In particular, the rubber is allowed to penetrate as far as the central channel delimited by the strands of the inner layer of the cord. Thus, in such a cord, the rubber penetrates within each strand and between the strands.

Preferably, the force at break of the cord is greater than or equal to 4000 N, preferably greater than or equal to 5000 N and more preferably greater than or equal to 6000 N.

Preferably, the total elongation at break At of the cord, i.e. the sum of its structural, elastic and plastic elongations (At=As+Ae+Ap), is greater than or equal to 4.5%, preferably greater than or equal to 5% and more preferably greater than or equal to 5.5%.

The structural elongation As results from the construction and the actual ventilation of the multistrand cord and/or of its elementary strands and also their intrinsic elasticity, where appropriate with a preformation imposed on one or more of these constituent strands and/or wires.

The elastic elongation Ae results from the actual elasticity of the metal of the metal wires, taken individually (Hooke's law).

The plastic elongation Ap results from the plasticity (irreversible deformation beyond the yield point) of the metal of these metal wires taken individually.

These different elongations and the meaning thereof, which are well known to a person skilled in the art, are described in documents U.S. Pat. No. 5,843,583, WO2005/014925 and WO2007/090603.

Advantageously, the cord has a structural elongation As greater than or equal to 1%, preferably greater than or equal to 1.5% and more preferably greater than or equal to 2%.

Thus, preferably, the cord is of the “HE” type, i.e. it has a high elasticity. The high value of its structural elongation makes it possible to characterize the ventilation of the cord, that is to say, on one hand, the separation of the wires with respect to the axial direction (direction perpendicular to the direction of the axis of the strand) and, on the other hand, the separation of the strands with respect to the axial direction (direction perpendicular to the direction of the axis of the cord). Specifically, the wires that constitute the strands and the strands that constitute the cord have a large curvature which separates them axially. This curvature is defined both by the helix diameter of each layer of wires or of strands and by the helix pitch or even by the helix angle of each layer of wires or of strands (angle measured from the axis of the cord).

In addition to making the cord elastic, this separation of the wires and of the strands with respect to the axis of the strand and the axis of the cord, respectively, encourages the rubber to pass between the wires of each strand and between the different strands. Resistance to corrosion is thus improved.

Thus, when the cord is used in a protective ply, the protective plies are rendered more resilient on account of the high elasticity of the cords according to the invention, which deform easily regardless of the road surface and are more resistant to corrosion on account of their penetrability.

Advantageously, K=3 or K=4.

Preferably, L=8 or L=9.

Advantageously, N=2, N=3 or N=4.

The preferred cords are cords of structure (3+8)×(2+2), (3+8)×(2+3), (3+8)×(2+4), (4+8)×(2+2), (4+8)×(2+3), (4+8)×(2+4), (4+9)×(2+2), (4+9)×(2+3) and (4+9)×(2+4).

It will be recalled here that, as is known, the pitch represents the length, measured parallel to the axis of the cord, after which a wire that has this pitch has made a complete turn around said axis of the cord.

According to optional features:

The inner wires of each of the K inner strands are wound in a helix at a pitch of between 3.6 and 16 mm, inclusive, preferably between 4 and 12.8 mm, inclusive.

The diameter of the inner wires of each of the K inner strands is between 0.18 mm and 0.40 mm, inclusive, preferably between 0.20 mm and 0.32 mm, inclusive.

The ratio of the pitch to the diameter of the inner wires of each of the K inner strands is between 20 and 40, inclusive.

The outer wires of each of the K inner strands are wound in a helix at a pitch of between 3.1 and 8.4 mm, inclusive, preferably between 3.4 and 6.7 mm, inclusive.

The diameter of the outer wires of each of the K inner strands is between 0.18 mm and 0.40 mm, inclusive, preferably between 0.20 mm and 0.32 mm, inclusive.

The ratio of the pitch to the diameter of the outer wires of each of the K inner strands is between 17 and 21, inclusive.

Thus, at a constant diameter, the outer wires preferably have a pitch shorter than that of the inner wires. The elasticity of each of the K strands is improved.

Preferably, the inner layer and outer layer of each of the K inner strands are wound in the same direction of twisting. In addition to promoting the elasticity of the cord, winding the inner layer and outer layer in the same direction minimizes friction between the two layers and therefore wear on the wires of which they are made.

According to other optional features:

The inner wires of each of the L outer strands are wound in a helix at a pitch of between 7.2 and 32 mm, inclusive, preferably between 8 and 25.6 mm, inclusive.

The diameter of the inner wires of each of the L outer strands is between 0.18 mm and 0.40 mm, inclusive, preferably between 0.20 mm and 0.32 mm, inclusive.

The ratio of the pitch to the diameter of the inner wires of each of the L outer strands is between 40 and 80, inclusive.

The outer wires of each of the L outer strands are wound in a helix at a pitch of between 4.1 and 13.2 mm, inclusive, preferably between 4.6 mm and 10.6 mm, inclusive.

The diameter of the outer wires of each of the L outer strands is between 0.18 mm and 0.40 mm, inclusive, preferably between 0.20 mm and 0.32 mm, inclusive.

The ratio of the pitch to the diameter of the outer wires of each of the L outer strands is between 23 and 33, inclusive.

Thus, at a constant diameter, the outer wires preferably have a pitch shorter than that of the inner wires. The elasticity of each of the L strands is improved.

Preferably, the inner layer and outer layer of each of the L outer strands are wound in the same direction of twisting. In a manner similar to the inner strands, the elasticity and wear resistance of the cord are therefore improved.

According to yet other optional features:

The inner strands are wound in a helix at a pitch of between 3.6 and 16 mm, inclusive, preferably between 4 and 12.8 mm, inclusive.

The ratio of the pitch of the inner strands to the diameter of the wires of each inner strand is between 20 and 40, inclusive. All the wires of each inner strand thus have the same diameter.

The outer strands are wound in a helix at a pitch of between 7.2 and 32 mm, inclusive, preferably between 8 and 25.6 mm, inclusive.

The ratio of the pitch of the outer strands to the diameter of the wires of each outer strand is between 40 and 80, inclusive. All the wires of each outer strand thus have the same diameter.

Thus, at a constant diameter, the outer strands preferably have a pitch larger than that of the inner strands.

Preferably, the inner layer and outer layer of the cord are wound in the same direction of twisting. This winding minimizes friction between the two layers and therefore wear on the wires of which they are made.

Advantageously, all of the wires and the strands are wound in the same direction of twisting. This promotes the elasticity of the cord.

For an optimized compromise between strength, capability of structural lengthening or elasticity, endurance and flexibility, it is preferable for the diameters of all of the outer wires and inner wires of each strand, whether or not these wires have an identical diameter, to be between 0.18 mm and 0.40 mm, inclusive, preferably between 0.20 mm and 0.32 mm, inclusive.

For each strand, the inner wires and outer wires may have an identical or different diameter from one layer to the other. Use is preferably made of wires that have the same diameter from one layer to the other. The inner wires of each strand are preferably made of steel, more preferably of carbon steel. Independently, the outer wires of each strand are preferably made of steel, more preferably of carbon steel.

Another subject of the invention relates to the use of a cord such as defined above as a reinforcing element in a tyre.

Another subject of the invention is a tyre comprising at least one cord such as defined above. Preferably, the tyre is intended for a construction plant type vehicle.

The cord of the invention is very particularly intended to be used as a reinforcing element for a crown reinforcement of a tyre intended for industrial vehicles chosen from heavy vehicles—i.e. metro vehicles, buses, road transport vehicles (lorries, tractors, trailers), off-road vehicles—, agricultural or construction plant machinery, and other transport or handling vehicles.

Preferably, the tyre has a carcass reinforcement anchored in two beads and surmounted radially by a crown reinforcement which is itself surmounted by a tread which is joined to said beads by two sidewalls, and said crown reinforcement has cords as defined above.

Advantageously, the cord according to the invention is intended to be used as a reinforcing element for a protective ply. As a variant, the cord according to the invention is intended to be used as a reinforcing element for a working ply.

The cord of the invention could also be used, in other embodiments, to reinforce other parts of tyres intended for other types of vehicles.

Thus, for example, it may be conceivable to use the cord as a reinforcing element for a hooping ply. According to different embodiments, such a hooping ply may be disposed radially between the carcass ply or plies and the working ply or plies, between the working plies, or between the working ply or plies and the protective ply or plies.

The invention will be better understood on reading the following description, given solely by way of example and with reference to the drawings, in which:

FIG. 1 is a view in section perpendicular to the axis of the cord (which is assumed to be straight and at rest) of a cord according to the invention;

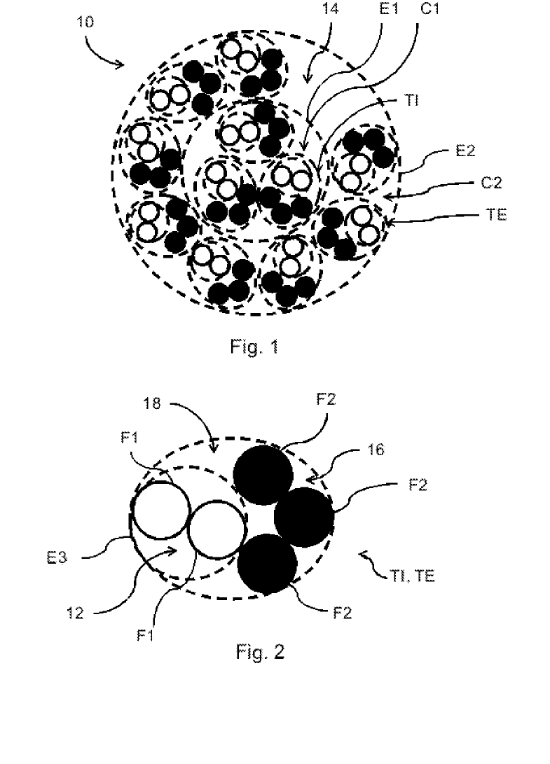

FIG. 2 is a detail view of a strand of the cord from FIG. 1;

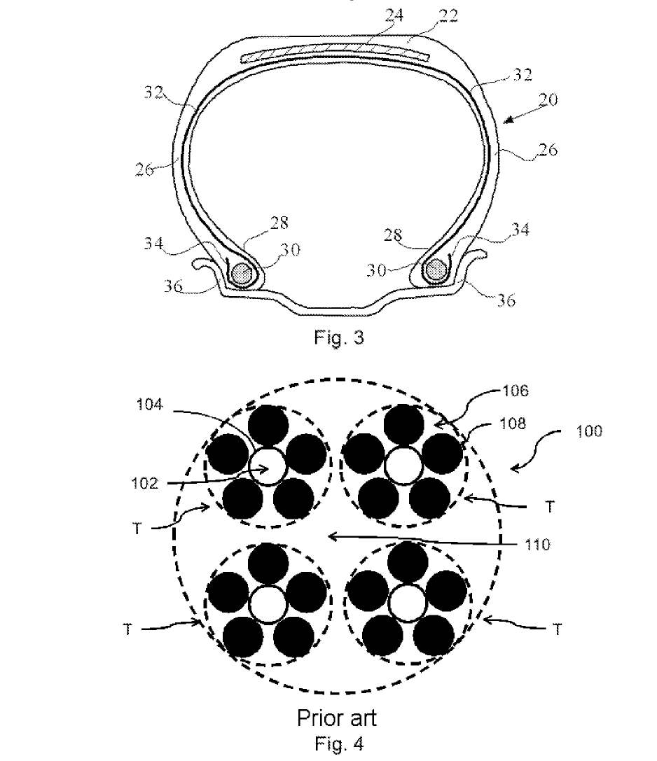

FIG. 3 is a view in section perpendicular to the circumferential direction of a tyre according to the invention;

FIG. 4 is a view similar to that of FIG. 1 of a prior art cord.

Cord According to the Invention

FIG. 1 shows an example of a metal cord according to the invention and denoted by the general reference 10. The cord 10 is of the multistrand type with two cylindrical layers. Thus, it will be understood that there are two layers of strands of which the cord 10 is made. The layers of strands are adjacent and concentric. The cord 10 is devoid of rubber when it is not integrated into the tyre.

The cord 10 comprises an inner layer C1 of the cord 10, said inner layer C1 being constituted of K inner strands TI, where preferably K=3 or K=4, and in this case K=3. The layer C1 has a substantially tubular envelope that gives the layer C1 its cylindrical contour E1.

The inner strands TI are wound in a helix at a pitch pl of between 3.6 and 16 mm, inclusive, preferably between 4 and 12.8 mm, inclusive. In this case, pl=7.5 mm.

The cord also comprises an outer layer C2 of the cord 10, said outer layer C2 being constituted of L outer strands TE, where preferably L=8 or L=9, and in this case L=8. The layer C2 has a substantially tubular envelope that gives the layer C2 its cylindrical contour E2.

The outer strands TE are side by side, this corresponding to a position of mechanical equilibrium, and at least two outer strands TE are separated by a passage opening 14 for the rubber. The inner layer C2 is unsaturated, that is to say there is sufficient room in the layer C2 to add at least one (L+1)th strand having the same diameter as the L strands of the layer C2 thereto, it thus being possible for a plurality of strands to be in contact with one another. Thus, the outer strands TE are arranged such that the layer C2 allows the rubber to pass radially between the outside and the inside of the layer C2 through the opening 14.

The outer strands TE are wound in a helix around the inner layer C1 at a pitch pE of between 7.2 and 32 mm, inclusive, preferably between 8 and 25.6 mm, inclusive. In this case, pE=15 mm.

The strands TI and TE are advantageously wound in the same direction of twisting, that is to say either in the S direction (“S/S” arrangement) or in the Z direction (“Z/Z” arrangement), in this case in the S/S arrangement.

FIG. 2 shows a strand TI, TE. Such a strand is referred to as an elementary strand.

Each strand TI, TE has an extended envelope that gives each strand TI, TE its elongate contour E3. Each strand TI, TE comprises an inner layer 12 constituted of 2 inner wires F1 and also an outer layer 16 constituted of N outer wires F2, where N=2, N=3 or N=4 and in this case N=3.

The outer wires F2 are generally side by side when the cord is at rest, this corresponding to a position of mechanical equilibrium, and at least two outer wires F2 are separated by a passage opening 18 for the rubber. The layer 16 is unsaturated, that is to say there is enough room in the layer 16 to add at least one (N+1)th outer wire F2 having the same diameter as the N outer wires F2 of the layer 16 thereto. Thus, the outer wires F2 of the layer 16 are arranged such that the layer 16 allows the rubber to pass radially between the outside and the inside of the layer 16 through the opening 18.

Each wire F1, F2 is preferably made of carbon steel coated with brass. The carbon steel wires are prepared in a known manner, for example from machine wire (diameter 5 to 6 mm) which is first of all work-hardened, by rolling and/or drawing, down to an intermediate diameter of around 1 mm. The steel used for the cord 10 is a carbon steel of the NT type (standing for “Normal Tensile”) with a carbon content of 0.7%, the rest consisting of iron and the usual inevitable impurities associated with the steel manufacturing process. As a variant, use is made of an SHT (“Super High Tensile”) carbon steel, the carbon content of which is around 0.92% and which comprises around 0.2% chromium.

The wires of intermediate diameter undergo a degreasing and/or pickling treatment prior to their subsequent conversion. After a brass coating has been applied to these intermediate wires, what is known as a “final” work-hardening operation is carried out on each wire (i.e. after the final patenting heat treatment) by cold drawing in a wet medium with a drawing lubricant for example in the form of an aqueous emulsion or an aqueous dispersion. The brass coating which surrounds the wires has a very small thickness, much less than one micron, for example around 0.15 to 0.30 μm, this being negligible compared with the diameter of the steel wires. Of course, the composition of the steel of the wire in terms of its various elements (for example C, Cr, Mn) is the same as that of the steel of the starting wire.

The inner wires F1 of each of the K inner strands TI are wound in a helix at a pitch p1,i of between 3.6 and 16 mm, inclusive, preferably between 4 and 12.8 mm, inclusive.

The diameter D1,i of the inner wires F1 of each of the K inner strands TI is between 0.18 mm and 0.40 mm, inclusive, preferably between 0.20 mm and 0.32 mm, inclusive. Preferably, all of the inner wires F1 of the K inner strands TI have the same diameter.

The inner wires F1 of each inner strand TI are wound such that the ratio R1,i of the pitch p1,i of the inner wires F1 to their diameter D1,i is between 20 and 40, inclusive. In this case, p1,i=7.5 mm, D1,i=0.26 mm and R1,i=28.8.

The outer wires F2 of each of the K inner strands TI are wound in a helix at a pitch p2,i of between 3.1 and 8.4 mm, inclusive, preferably between 3.4 and 6.7 mm, inclusive.

The diameter D2,i of the outer wires F2 of each of the K inner strands TI is between 0.18 mm and 0.40 mm, inclusive, preferably between 0.20 mm and 0.32 mm, inclusive. Preferably, all of the outer wires F2 of the K inner strands TI have the same diameter.

The outer wires F2 of each inner strand TI are wound in a helix around the inner layer 12 such that the ratio R2,i of the pitch p2,i of the outer wires F2 of each inner strand TI to their diameter D2,i is between 17 and 21, inclusive. In this case, p2,i=5 mm, D2,i=0.26 mm and R2,i=19.2.

The inner wires F1 of each of the L outer strands TE are wound at a pitch p1,e of between 7.2 and 32 mm, inclusive, preferably between 8 and 25.6 mm, inclusive.

The diameter D1,e of the inner wires F1 of each of the L outer strands TE is between 0.18 mm and 0.40 mm, inclusive, preferably between 0.20 mm and 0.32 mm, inclusive. Preferably, all of the inner wires F1 of the L outer strands TE have the same diameter.

The inner wires F1 of each outer strand TE are wound such that the ratio R1,e of the pitch p1,e of the inner wires F1 to their diameter D1,e is between 40 and 80, inclusive. In this case, p1,e=15 mm, D1,e=0.26 mm and R1,e=57.7.

The outer wires F2 of each of the L outer strands TE are wound at a pitch p2,e of between 4.1 and 13.2 mm, inclusive, preferably between 4.6 mm and 10.6 mm, inclusive.

The diameter D2,e of the outer wires F2 of each of the L outer strands TE is between 0.18 mm and 0.40 mm, inclusive, preferably between 0.20 mm and 0.32 mm, inclusive. Preferably, all of the outer wires F2 of the L outer strands TE have the same diameter.

The outer wires F2 of each outer strand TE are wound in a helix around the inner layer 12 such that the ratio R2,e of the pitch p2,e of the outer wires F2 of each outer strand TE to their diameter D2,e is between 23 and 33, inclusive. In this case, p2,e=7.5 mm, D2,e=0.26 mm and R2,e=28.8.

Preferably, all of the wires F1 and F2 have the same diameter.

The inner strands TI are wound in a helix such that the ratio RI of the pitch pl of the inner strands TI to the diameter D1,i, D2,i of the wires F1, F2 of each inner strand TI is between 20 and 40, inclusive. In this case, RI=28.8.

The outer strands TE are wound in a helix around the inner layer C1 such that the ratio RE of the pitch pE of the outer strands TE to the diameter D1,e, D2,e of the wires F1, F2 of each outer strand TE is between 40 and 80, inclusive. In this case, RE=57.7.

The wires F1, F2 of each strand TI, TE are advantageously wound in the same direction of twisting, that is to say either in the S direction (“S/S” arrangement) or in the Z direction (“Z/Z” arrangement), in this case in the S/S arrangement.

Thus, all of the wires F1, F2 and all of the strands TI, TE are wound in the same direction of twisting S. As a variant, they are all wound in the same direction of twisting Z.

FIG. 4 shows the prior art cord, denoted by the general reference 100.

This cord 100 has a structure of the 4×(1+5) type and comprises four strands T that each comprise an inner layer 102 constituted of one wire 104 and an outer layer 106 constituted of five wires 108 wound in a helix around the wire 104 of the inner layer 102. The strands T delimit a central channel 110.

A method for manufacturing the cord according to the invention will now be described.

Beforehand, it will be recalled that there are two possible techniques for assembling metal wires or strands:

either by cabling: in which case the wires or strands undergo no twisting about their own axis, because of a synchronous rotation before and after the assembling point;

or by twisting: in which case the wires or strands undergo both a collective twist and an individual twist about their own axis, thereby generating an untwisting torque on each of the wires or strands.

Assembly of Each Strand TI and TE

First of all, each elementary strand TI and TE is formed as follows.

During a twisting assembly step, the N inner wires F2 that constitute the outer layer 16 are wound in a helix at an intermediate pitch equal to 15 mm in the S direction around the 2 inner wires F1 that constitute the inner layer 12. During this step, the inner wires F1 are parallel and thus have an infinite intermediate pitch.

Assembly of the Cord 10

Next, the cord 10 is assembled as follows.

During a twisting assembly step, K inner strands TI that were previously formed during the step of forming strands TI and constitute the inner layer C1 are wound in a helix at what is referred to as an initial pitch, equal to 7.5 mm, in the S direction.

Then, during another twisting assembly step that is or is not implemented in line with the preceding twisting step, the outer layer C2 that is constituted of L outer strands TE that were previously formed during the step of forming the strands TE is wound in a helix at what is referred to as an initial pitch, equal to 15 mm, in the S direction around the inner layer C1 of the K inner strands previously wound in a helix. The strands TI, TE and the wires F1, F2 of the layers C1, C2 thus have the initial pitches mentioned in Table 1. As a variant, they have other initial pitches.

TABLE 1

| Layer | Strand | Wires | Pitch | |
|---|---|---|---|---|
| C1 | TI | | 7.5 | mm |
| | | F1 | 7.5 | mm |
| | | F2 | 5 | mm |
| C2 | TE | | 15 | mm |
| | | F1 | 15 | mm |
| | | F2 | 7.5 | mm |

Next, a step of overtwisting the cord 10 is carried out. Thus, the wires F1, F2 and the strands TE, TI that were previously wound are overtwisted, that is to say that the cord 10 is twisted further in the S direction. During this overtwisting step, the respective initial pitches of the wires F1, F2 and of the stands TI, TE are reduced so as to obtain intermediate pitches smaller than the corresponding initial pitches.

Then, a step of balancing the overtwisted cord 10 is carried out so as to obtain zero residual torque in the cord 10. To this end, the cord is passed through balancing means of the rotary type. The term “balancing” is understood here, in a manner known to a person skilled in the art, as meaning the cancelling out of residual twisting torque (or of untwisting spring-back) that is exerted both on each wire of the cord in the twisted state and on each strand of the cord in the twisted state. The balancing means are known to a person skilled in the art of twisting. They may consist for example of twisters that comprise for example one, two or four pulleys, through which the cord runs, in a single plane.

Next, a step of untwisting the overtwisted and balanced cord is carried out. Thus, the wires F1, F2 and the strands TE, TI of the previously balanced cord 10 are untwisted, that is to say that the cord 10 is twisted in the Z direction. Thus, the intermediate pitches of the wires F1, F2 and of the strands TE, TI are increased in order to obtain the initial pitches. At the end of this untwisting step, the pitches of the wires F1, F2 and of the strands TI, TE are thus those of Table 1 again.

Finally, preferably, the cord 10 is wound onto a storage spool.

The above-described cord 10 is able to be obtained by the above-described method.

Tyre According to the Invention

FIG. 3 shows a tyre according to the invention and denoted by the general reference 20.

The tyre 20 has a crown 22 reinforced by a crown reinforcement 24, two sidewalls 26 and two beads 28, each of these beads 28 being reinforced with a bead wire 30. The crown 22 is surmounted by a tread, not shown in this schematic figure. A carcass reinforcement 32 is wound around the two bead wires 30 in each bead 28 and comprises a turn-up 34 disposed towards the outside of the tyre 20, which is shown fitted onto a wheel rim 36 here. The carcass reinforcement 32 is, in a way known per se, made of at least one ply reinforced by what are known as “radial” cords which means that these cords run practically parallel to one another and extend from one bead to the other to form an angle of between 80° and 90° with the circumferential median plane (plane perpendicular to the axis of rotation of the tyre and which is situated midway between the two beads 28 and passes through the middle of the crown reinforcement 24).

The crown reinforcement 24 has at least one crown ply of which the reinforcing cords are metal cords in accordance with the invention. In this crown reinforcement 24 that is depicted in a very simple manner in FIG. 3, it will be understood that the cords of the invention may for example reinforce all or some of the working crown plies, or triangulation crown plies (or half plies) and/or protective crown plies, when such triangulation or protective crown plies are used. Besides the working plies, and the triangulation and/or protective plies, the crown reinforcement 24 of the tyre of the invention can of course have other crown plies, for example one or more hooping crown plies.

Of course, the tyre 20 additionally comprises, in a known manner, an inner layer of rubber or elastomer (commonly known as “inner liner”) which defines the radially inner face of the tyre and which is intended to protect the carcass ply from the diffusion of air originating from the space inside the tyre. Advantageously, in particular in the case of a tyre for a heavy vehicle, it may also comprise an intermediate reinforcing elastomer layer which is located between the carcass ply and the inner layer, intended to reinforce the inner layer and, consequently, the carcass layer, and also intended to partially delocalize the forces undergone by the carcass reinforcement.

In this belt ply, the density of the cords in accordance with the invention is preferably between 15 and 80 cords per dm (decimetre) of belt ply, inclusive, more preferably between 35 and 65 cords per dm of ply, inclusive, the distance between two adjacent cords, axis to axis, preferably being between around 1.2 and 6.5 mm, inclusive, more preferably between around 1.5 and 3.0 mm, inclusive.

The cords in accordance with the invention are preferably disposed such that the width (denoted L) of the bridge of rubber between two adjacent cords is between 0.5 and 2.0 mm, inclusive. This width L represents, in a known manner, the difference between the calendering pitch (the pitch at which the cord is laid in the rubber fabric) and the diameter of the cord. Below the minimum value indicated, the bridge of rubber, which is too narrow, runs the risk of being mechanically degraded when the ply is working, in particular during the deformations undergone in its own plane under extension or shear. Above the maximum indicated, there is a risk of objects penetrating, by perforation, between the cords. More preferably, for these same reasons, the width L is chosen to be between 0.8 and 1.6 mm, inclusive.

Preferably, the rubber composition used for the fabric of the belt ply has, in the vulcanized state (i.e. after curing), a secant modulus in extension E10 of between 5 and 25 MPa, inclusive, more preferably between 5 and 20 MPa, inclusive, in particular in a range from 7 to 15 MPa, inclusive, when this fabric is intended to form a belt ply, for example a protective ply. It is in such ranges of moduli that the best endurance compromise between the cords of the invention on the one hand and the fabrics reinforced by these cords on the other has been recorded.

A method of manufacturing the tyre according to the invention will now be described.

The cord 10 is incorporated by calendering into composite fabrics formed from a known composition based on natural rubber and carbon black as reinforcing filler, conventionally used for manufacturing crown reinforcements of radial tyres. This composition essentially has, in addition to the elastomer and the reinforcing filler (carbon black), an antioxidant, stearic acid, an oil extender, cobalt naphthenate as adhesion promoter, and finally a vulcanization system (sulphur, accelerator and ZnO).

The composite fabrics reinforced by these cords have a rubber matrix formed from two thin layers of rubber which are superposed on either side of the cords and which have a thickness of between 0.5 mm and 0.8 mm, inclusive, respectively. The calendering pitch (the pitch at which the cord is laid in the rubber fabric) is between 1.3 mm and 2.8 mm, inclusive.

These composite fabrics are then used as protective ply in the crown reinforcement during the method of manufacturing the tyre, the steps of which are otherwise known to a person skilled in the art.

Measurements and Comparative Tests

The cord 10 according to the invention was compared with the prior art cord 100 of structure 4×(1+5).

The diameter of each wire 104, 108 of the cord 100 is equal to 0.26 mm. The pitch P of the strands 106 is equal to 8 mm and the pitch p of the wires 108 around the wire 104 is equal to 5 mm.

Dynamometric Measurements

For metal cords, force at break, denoted Fm (maximum load in N), is measured under tension in accordance with standard ISO 6892, 1984. The measurements of total elongation at break (At) and capability of structural lengthening or elongation (As) (elongations in %) are well known to a person skilled in the art and described for example in document US 2009/294009 (cf. FIG. 1 and the description relating thereto).

The following Table 2 shows the results obtained for force at break Fm and structural elongation.

TABLE 2

| | Force at break | Structural elongation | Total elongation |
|---|---|---|---|
| Cord | (Fm) | (As) | (At) |
| 10 | 6325 N | 1.8% | 5.5% |
| 100 | 2750 N | 1.8% | 5.5% |

The cord 10 has a total elongation at break At greater than or equal to 4.5%, preferably greater than or equal to 5% and more preferably greater than or equal to 5.5%.

The cord 10 has a structural elongation As greater than or equal to 1%, preferably greater than or equal to 1.5%. In a variant that is not shown, the structural elongation As is greater than or equal to 2%.

The force at break of the cord 10 is greater than or equal to 4000 N, preferably greater than or equal to 5000 N and even greater than or equal to 6000 N.

The cord 10 of the invention has a force at break 2.3 times greater than the cord 100 while retaining its properties of structural elongation and thus its elasticity. This elasticity is, as described above, representative of the ventilation of the cord, which also favours the high penetrability of the cord with the rubber.

Air Permeability Test

This test makes it possible to determine the longitudinal permeability to air of the cords tested, by measuring the volume of air that passes through a test specimen under constant pressure in a given time. The principle of such a test, which is well known to a person skilled in the art, is to demonstrate the effectiveness of the treatment of a cord to make it impermeable to air; it has been described for example in standard ASTM D2692-98.

The test is performed here either on cords that have been extracted from tyres or rubber plies that they reinforce, and have thus already been coated from the outside with rubber in the cured state, or on as-manufactured cords.

In the latter case, the as-manufactured cords need to be coated from the outside beforehand with a rubber referred to as coating rubber. For this purpose, a series of 10 cords laid parallel (distance between cords: 20 mm) is placed between two layers or “skims” (two rectangles measuring 80×200 mm) of a diene rubber compound in the raw state, each skim having a thickness of 3.5 mm; all of this is then immobilized in a mould, with each of the cords kept under sufficient tension (for example 2 daN) to guarantee that it lies straight as it is being placed in the mould, using clamping modules; it is then vulcanized (cured) for 40 min at a temperature of 140° C. and at a pressure of 15 bar (rectangular piston measuring 80×200 mm). After that, the entirety is removed from the mould and ten test specimens of cords thus coated are cut out, for characterizing, in the shape of parallelepipeds measuring 7×7×20 mm.

The compound used as a coating rubber is a diene rubber compound conventionally used in tyres, based on natural (peptized) rubber and carbon black N330 (65 phr), also containing the following usual additives: sulphur (7 phr), sulphenamide accelerator (1 phr), ZnO (8 phr), stearic acid (0.7 phr), antioxidant (1.5 phr), cobalt naphthenate (1.5 phr) (phr meaning parts by weight per hundred parts of elastomer); the E10 modulus of the coating rubber is around 10 MPa.

The test is carried out on a 2 cm length of cord, which is thus coated with its surrounding rubber composition (or coating rubber) in the cured state, in the following manner: air is sent to the inlet of the cord, under a pressure of 1 bar, and the volume of air at the outlet is measured using a flow meter (calibrated, for example, from 0 to 500 cm3/min). During the measurement, the sample of cord is immobilized in a compressed airtight seal (for example, a seal made of dense foam or of rubber) so that only the amount of air passing along the cord from one end to the other, along its longitudinal axis, is taken into account by the measurement; the airtightness of the airtight seal itself is checked beforehand using a solid rubber test specimen, that is to say one devoid of cord.

The higher the longitudinal impermeability of the cord, the lower the mean air flow rate measured (averaged over the ten specimens). As the measurement is taken with a precision of ±0.2 cm3/min, measured values of less than or equal to 0.2 cm3/min are considered to be zero; they correspond to a cord that can be described as airtight (completely airtight) along its axis (i.e. in its longitudinal direction).

The cord 10 was subjected to the air permeability test described above, by measuring the volume of air (in cm³) passing along the cords in one minute (averaged over 10 measurements).

The average air flow rate measured on the cord 10 is zero, which means that for each test specimen, the air flow rate measured is less than or equal to 0.2 cm3/min.

The cord 10 of the invention thus has very low permeability to air, since it is virtually zero (average air flow rate of zero), and consequently a higher rate of penetration by the rubber. The cord 10 according to the invention thus improves corrosion resistance notably.

Of course, the invention is not restricted to the exemplary embodiments described above.

For example, some wires could have a non-circular, for example plastically deformed, cross section, in particular a cross section which is oval or polygonal, for example triangular, square or even rectangular.

The wires, having or not having a circular cross section, for example a wavy wire, could be twisted or contorted into the shape of a helix or a zigzag. In such cases, it should of course be understood that the diameter of the wire represents the diameter of the imaginary cylinder of revolution that surrounds the wire (envelope diameter), and no longer the diameter (or any other transverse size, if the cross section thereof is not circular) of the core wire itself.

For reasons of industrial feasibility, cost and overall performance, the invention is preferably implemented with linear wires, that is to say ones that are straight, having a conventional circular cross section.

It may also be possible to combine the features of the different embodiments described or envisaged above, as long as these are compatible with one another.

1-32. (canceled)

33. A two-layer multistrand metal cord, comprising:
an inner cord layer, which is formed of K>1 inner strands wound in a helix; and
an outer cord layer, which is unsaturated and which is formed of L>1 outer strands wound in a helix around the inner cord layer,
wherein each strand of the inner cord layer and the outer cord layer includes:
an inner strand layer, which is formed of two inner wires, and
an outer strand layer, which is formed of N outer wires wound in a helix around the inner strand layer.

34. The cord according to claim 33, wherein the outer strand layer of each strand is unsaturated.

35. The cord according to claim 33, wherein a structural elongation (As) of the cord is greater than or equal to 1%.

36. The cord according to claim 33, wherein a structural elongation (As) of the cord is greater than or equal to 1.5%.

37. The cord according to claim 33, wherein a structural elongation (As) of the cord is greater than or equal to 2%.

38. The cord according to claim 33, wherein a total elongation at break (At) of the cord is greater than or equal to 4.5%.

39. The cord according to claim 33, wherein a total elongation at break (At) of the cord is greater than or equal to 5%.

41. The cord according to claim 33, wherein a total elongation at break (At) of the cord is greater than or equal to 5.5%.

42. The cord according to claim 33, wherein K=3 or K=4.

43. The cord according to claim 33, wherein L=8 or L=9.

44. The cord according to claim 33, wherein N=2, N=3, or N=4.

45. A tyre comprising at least one cord, wherein each cord of the at least one cord includes:
an inner cord layer, which is formed of K>1 inner strands wound in a helix; and
an outer cord layer, which is unsaturated and which is formed of L>1 outer strands wound in a helix around the inner cord layer,
wherein each strand of the inner cord layer and the outer cord layer includes:
an inner strand layer, which is formed of two inner wires, and
an outer strand layer, which is formed of N outer wires wound in a helix around the inner strand layer.

46. The tyre according to claim 45, further comprising:
two beads;
a carcass reinforcement anchored in the two beads;
a crown reinforcement positioned to radially surmount the carcass reinforcement;
a tread positioned to radially surmount the crown reinforcement; and
two sidewalls positioned to join the two beads to the tread,
wherein the crown reinforcement incorporates the at least one cord.

47. The tyre according to claim 45, wherein the tyre is incorporated in a construction-plant type vehicle.

48. The tyre according to claim 46, wherein the tyre is incorporated in a construction-plant type vehicle.
